(19) United States
(12) Patent Application Publication
(10) Pub. No.: US 2003/0042768 A1
(43) Pub. Date: Mar. 6, 2003

(54) Chair material storing device

(76) Inventor: Annalee Koehn, Chicago, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/229,508

(22) Filed: Aug. 28, 2002

Related U.S. Application Data
(60) Provisional application No. 60/315,625, filed on Aug. 29, 2001.

(51) Int. Cl. B60N 2/48

(52) U.S. Cl. 297/188.01

(57) ABSTRACT

A device for adding storage to a chair having a seat includes at least one pocket to be supported adjacent the seat of the chair. The device also includes a securing mechanism which, in embodiments having a single pocket, can comprise a continuous strap to be looped around the back of a chair, a string secured to each of opposite sides of the pocket to be tied together about the back of the chair, a hollow sleeve to be slipped down over the back of the chair, or a pair of straps on each corner of an integral seat portion opposite the single pocket to be secured to one of the legs of the chair. The securing mechanism, in embodiments having a pair of pockets, can comprise a seat portion integral with each of the pockets to cover the seat of the chair such that the pockets are positioned on opposite sides of the chair to rest against and be supported by the legs of the chair without other components, a single strap on each side of the seat portion to be secured to one of the legs of the chair, or a pair of straps on every corner of the seat portion to be secured to each of the legs of the chair. Further, the chair storage device can be formed of rigid or flexible materials, can have a padded seat, and can have indicia thereon.

### RELATED APPLICATIONS

This application claims priority from U.S. provisional patent application Ser. No. 60/315,625, filed Aug. 29, 2001.

### FIELD OF THE INVENTION

The invention generally relates to maximizing the use of space by providing storage associated with a chair and, more particularly, providing for the storage of educational materials where the storage is associated with a classroom chair.

### BACKGROUND OF THE INVENTION

In recent years, there has been a proliferation of educational materials that are regularly being used for a wide variety of purposes. It is recognized, for example, that educational materials of every type and kind, including those in various forms of media, are utilized almost daily in the classroom. As a result, the opportunity for education at enhanced levels using a multitude of materials has never been more available.

Of course, it is also recognized that the availability of so many educational materials has produced a very real problem within the classroom environment. These materials must be readily accessible when needed and, thus, should be almost immediately within reach in the classroom. However, it is generally known that many schools were built years ago when perceived requirements for classroom space were very different than they are today.

In other words, most classrooms were built at a time when space requirements were far less than in the modem world. It is, therefore, almost always difficult to find adequate storage space for the many new educational materials that have been developed and are currently being used by teachers at every level of education. For this reason, there has been a growing need for ways to better utilize the precious space that is available in existing classrooms.

Still further, it would be beneficial to be able to ship educational materials in a device having pockets therefore where the device could be used following shipment for adding storage to a chair for the very same educational materials thereby giving the device at least this dual functionality.

### SUMMARY OF THE INVENTION

In accordance with one aspect of the invention, a device for adding storage to a chair is provided which includes a pair of pockets, each of which is adapted to be supported on opposite sides of a chair. The pockets are interconnected by a seat portion that spans the width of the chair seat, and the device may be formed of either a rigid material or a material such as canvas or vinyl which is characterized by its flexibility and durability. If desired, the device can be provided with graphic designs, publisher information, and/or trademarks which are integral with, printed, or otherwise placed on a visible surface thereof.

In accordance with another aspect of the invention, a device for adding storage to a chair may also incorporate a padded seat cushion. The padded seat cushion may comprise the seat portion by which the pockets are interconnected. As such, the padded seat cushion may span the width of the chair seat so that the pockets are on either side thereof.

In accordance with yet another aspect of the invention, the chair storage device may include means for securing the pocket or pockets to a chair. This may comprise a continuous strap, a pair of strings, a back-receiving hollow sleeve, or a strap or pairs of straps associated with the device. Preferably, the straps or strings are of sufficient length to be secured to the legs or back of the chair to maintain the position of the device thereon.

In accordance with still another aspect of the invention, a device for adding storage to a chair is provided which has a single pocket. The single pocket may be disposed on either side of the chair or on the back of the chair, and it can be formed in like manner to the double pocket version, i.e., either of a rigid material or a flexible material such as canvas, vinyl, or any other fabric or material. In addition, the device can be formed to have a single pocket with suitable means for securing the pocket in position on the side or lower back of the chair.

In a slight variation of the single pocket version of the device, the pocket can have a sleeve associated with a back surface of the pocket to be slipped down over the back of the chair-to provide easy access from the rear of the chair to the materials stored therein.

In accordance with a still further aspect of the invention, the device may be utilized to ship educational materials in the pocket or pockets in addition to adding storage to a chair for the educational materials in a classroom environment following shipment.

### BRIEF DESCRIPTION OF THE DRAWINGS

FIG. 1a is a perspective view of a first embodiment of a device for adding storage to a chair for materials in accordance with the present invention;

FIG. 1b is a perspective view similar to FIG. 1a with the materials removed from the device to better show the pockets which hold the materials;

FIG. 1c is a perspective view of the device illustrated in FIG. 1b removed from the chair to better show the intermediate seat covering portion;

FIG. 1d is a perspective view of another embodiment of the device similar to FIG. 1c which incorporates tabs for securing the device to a chair;

FIG. 1e is a perspective view of still another embodiment of the device similar to FIG. 1c which incorporates a padded seat cushion;

FIG. 2a is a perspective view of a further embodiment of the device for adding storage to a chair for materials in a single pocket on the side of the chair;

FIG. 2b is a perspective view similar to FIG. 2a with the device removed from the chair to better show the single pocket which holds the materials;

FIG. 2c is a perspective view similar to FIG. 2b with the materials removed from the device to better show the single pocket which holds the materials;

FIG. 3a is a perspective view of yet another embodiment of the device for adding storage to a chair for materials in a single pocket on the back of the chair;

FIG. 3b is a perspective view similar to FIG. 3a with the materials removed from the device to better show the single pocket which holds the materials;

FIG. 4a is a perspective view of yet a further embodiment of the device for adding storage to a chair for materials in a single pocket on the back of the chair; and

FIG. 4b is a perspective view similar to FIG. 4a with the device removed from the chair to better show the single pocket which holds the materials.

### DETAILED DESCRIPTION OF THE PREFERRED EMBODIMENTS

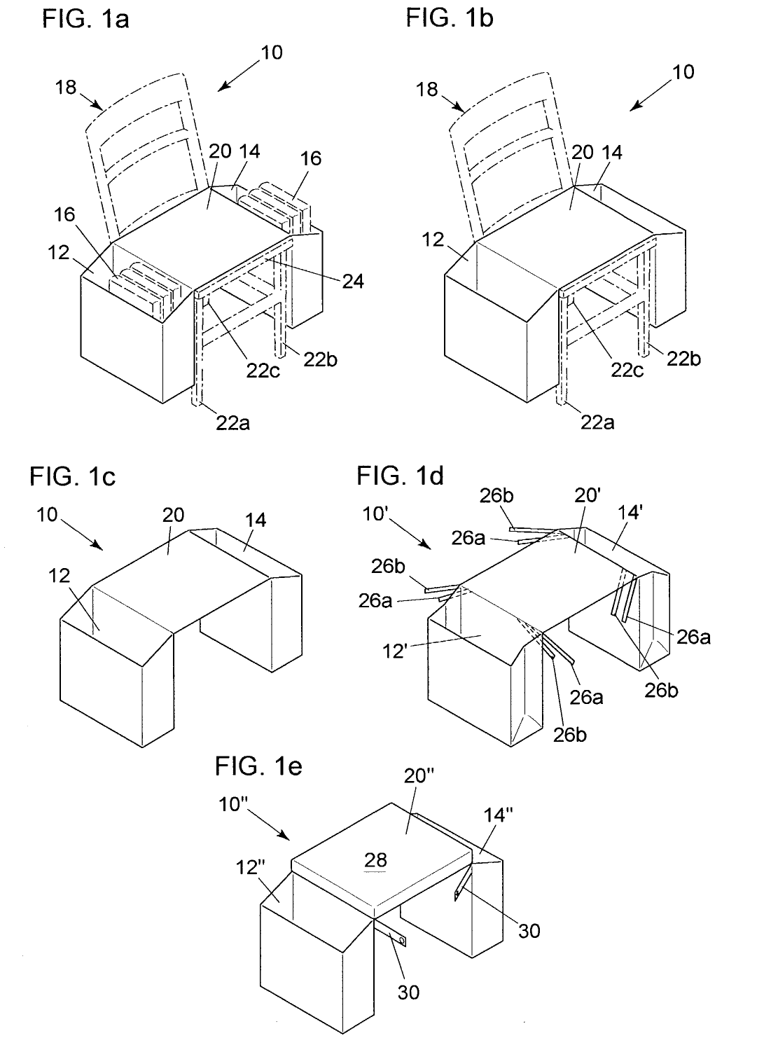

Referring to the drawings, and with specific reference to FIGS. 1a-1c, a device for adding storage to a chair having a seat, and constructed in accordance with the present invention, is generally designated by reference numeral 10. The chair storage device 10 includes a pair of pockets 12 and 14 which are well suited for receiving and storing materials, e.g., educational materials, such as those denoted by reference numeral 16. As shown in FIG. 1a, the pockets 12 and 14 can be disposed on opposite sides of a chair 18 to provide unique storage capability while rendering the educational materials 16 readily available for use in the classroom at any time.

With specific reference to FIG. 1c, the chair storage device 10, which is shown separate from the chair, suitably includes an intermediate seat covering portion 20 that interconnects the pockets 12 and 14. Thus, the pockets 12 and 14 may hang at the sides of the chair 18 and rest against the legs such as 22a, 22b, and 22c which provide full side support for the typically heavy books or other materials in a relatively balanced manner wherein the seat covering portion 20 serves to secure the device 10 in position. In this connection, the chair storage device 10 may be formed of any of a variety of materials of different strength due to the degree of support which is provided by the legs of the chair such as 22a, 22b, and 22c.

More specifically, the chair storage device 10 may be formed of a rigid material such as plastic or the like. Alternatively, it could be formed of canvas, vinyl or any other fabric for flexibility and durability as in the embodiment illustrated in FIG. 1d. In either case, the chair storage device 10 can rest upon and/or otherwise be connected to the seat 24 of the chair 18.

As shown, the seat covering portion 20 is integral with a top edge of a back surface of each of the pockets 12 and 14 so as to cover the seat 24 of the chair 18, and the respective pairs of legs of the chair 18 on each of then opposite sides thereof serve as opposite side supports for the pockets 12 and 14 which rest against them when the seat covering portion 20 covers the seat 24 of the chair 18..

The chair storage device 10 can have graphic designs, publisher information, and/or trademarks regardless of the material. For instance, the indicia on a visible surface of the device 10 can be integral with, printed, or otherwise placed onto plastic, canvas, vinyl or any other fabric, or it can be integrally woven into fabric. Of course, the chair storage device 10 can also be formed of any such material which is provided in one or more solid colors.

Referring now to FIGS. 1d and 1e, a first alternative chair storage device 10′ and a second alternative chair storage device 10″, respectively, are disclosed. The chair storage device 10′ generally corresponds to the device 10 described above in that it also includes a pair of pockets 12′ and 14′ which are interconnected by an intermediate seat covering portion 20′ wherein the entirety of the chair storage device 10′ is formed of canvas, vinyl or any other fabric for flexibility and durability. In this form, the device 10′ can be provided with means for securing the pockets 12 and 14 to the chair 18 adjacent the seat 24 thereof.

In particular, the securing means may suitably comprise a pair of straps 26a and 26b provided on each of the corners of the seat covering portion 20′ generally adjacent the pockets 12 and 14. As will be appreciated, the pairs of straps 26a and 26b may then be used to positively secure the device 10 to each of the legs of the chair 18. If desired, the straps 26a and 26b can be formed with cooperating hook and loop fasteners, or they may simply comprise tie strings to be tied about the legs such as 22a, 22b, and 22c of the chair 18.

With regard to FIG. 1e, the chair storage device 10″ also includes a pair of pockets 12″ and 14″ interconnected by an intermediate seat covering portion 20″. The principal difference between the device 10 illustrated in FIGS. 1a-1c and the device 10″ is that the intermediate seat covering portion 20″ incorporates a padded seat cushion 28 to directly overlie the seat 24 of the chair 18. Also, the device 10″ can be provided with means for securing the pockets 12″ and 14″ to the chair 18 adjacent the seat 24 thereof.

In particular, the securing means may suitably comprise at least one tab or strap 30 on each side of the seat covering portion 20″. As will be appreciated from, the tabs or straps 30 may then be used to positively secure the device 10″ to one of the legs of the chair 18 on each of opposite sides thereof. If desired, the straps 30 can be formed with snaps for securing them to the legs such as 22a, 22b, and 22c of the chair 18.

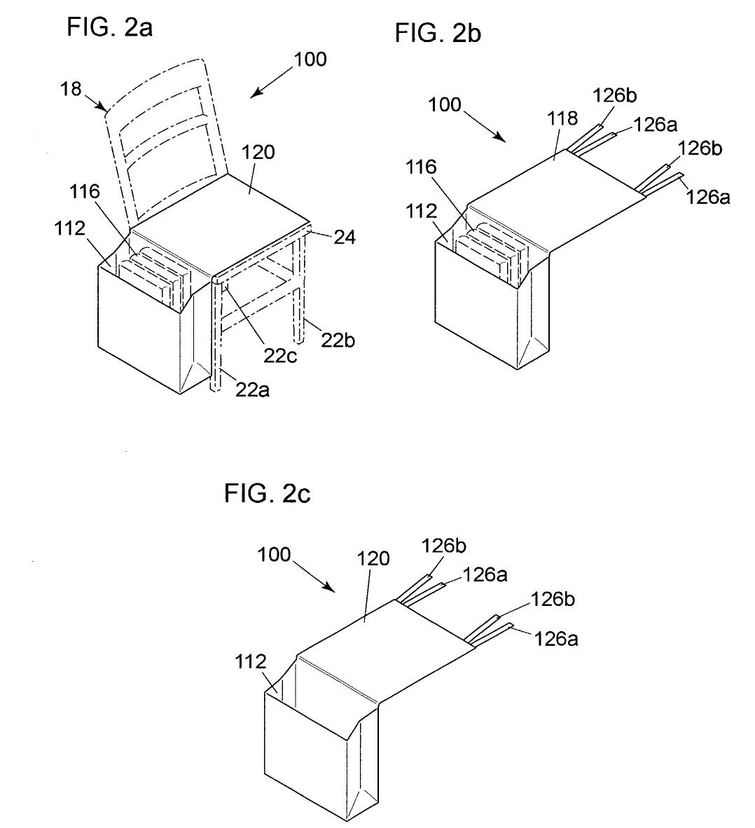

Referring now to FIGS. 2a-2c, a chair storage device 100 for educational materials 116 is illustrated which differs from the chair storage devices illustrated in FIGS. 1a-1e in that it includes only a single pocket 112. It also includes a seat covering portion 120 integral with a top edge of a back surface of the pocket 112 which is adapted to be disposed over the seat 24 of the chair 18, but it does not include a second pocket which is positioned directly opposite the first pocket 112 in the manner of the embodiments of FIGS. 1a-1d. In addition, and as clearly shown in FIGS. 2b and 2c, the device 100 can be provided with means for securing the pocket 112 to the chair 18 adjacent the seat 24 thereof on the side opposite the pocket 112.

In particular, the securing means may suitably comprise a pair of straps 126a and 126b provided on each of the corners of the seat covering portion 120 generally opposite the pocket 112. As will be appreciated, the pairs of straps 126a and 126b on the corners of the seat covering portion 120 opposite the pocket 112 may be used to positively secure the device 10 to each of the legs of the chair 18 on the side of the chair 18 opposite the pocket 112. If desired, the straps 26a and 26b can be formed with cooperating hook and loop fasteners, or they may simply comprise tie strings to be tied about the legs such as 22b, and 22c of the chair 18.

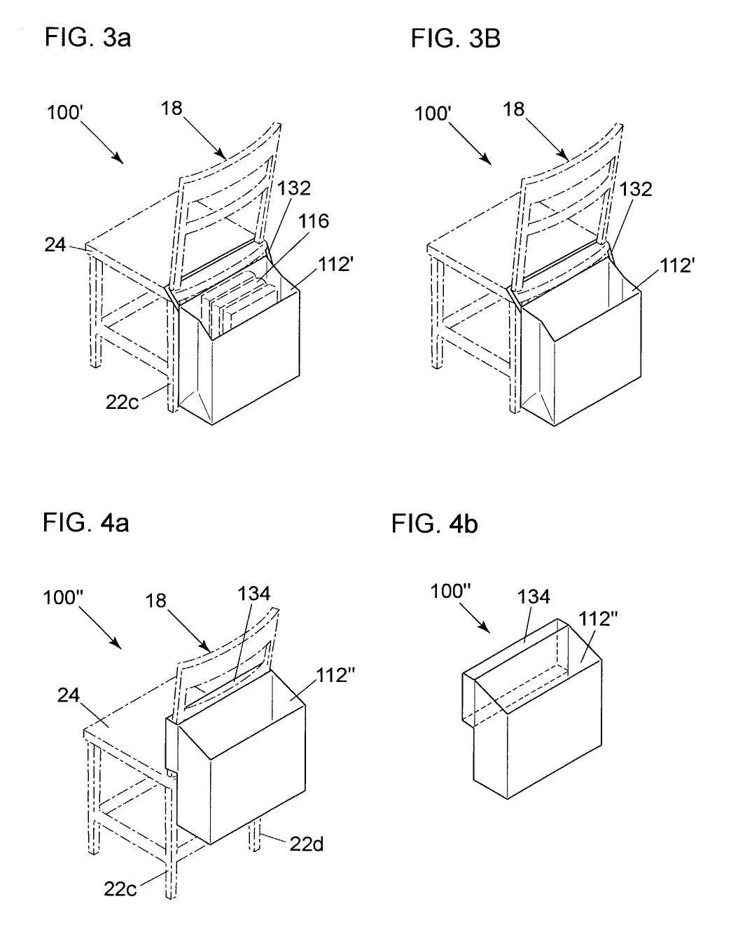

Referring now to FIGS. 3a and 3b, a chair storage device 100′ comprised of a single pocket 112′ is illustrated which represents a variation of the chair storage device 100 illustrated in FIGS. 2a-2c. The device 100′, which has educational materials 116′ disposed in the single pocket 112′ in FIG. 3a, is provided with a continuous strap 132 (which, alternatively, could be a string secured to each of opposite sides of the pocket 112′ so as to be tied together) which serves to secure the single pocket 112′ around the back of the chair 18. In the embodiments of FIGS. 2a-2c and 3a-3b, the chair storage devices 100 and 100′ are formed so the single pockets 112 and 112′ rests against, and are supported by, an adjacent pair of legs of the chair 18.

More specifically, the chair storage device 100 rests against the leg 22a and the rear leg (not shown) opposite the rear leg 22c whereas the device 100′ rests against the leg 22c and the rear leg (not shown) opposite the rear leg 22c.

Finally, FIGS. 4a and 4b illustrate a chair storage device 100″ which also comprises a single pocket 112″. This embodiment is similar to the chair storage device 100′ illustrated in FIGS. 3a and 3b with the exception of the way in which it is attached to the back of the chair 18. As shown, the chair storage device 100″ includes a hollow sleeve 134 extending across a back surface of the pocket 112″.

More particularly, the hollow sleeve 134 is provided so that the chair storage device 100″ may be placed on the chair 18 by slipping the sleeve 134 down over the back of the chair 18 to the level of the seat 24.

As with the chair storage device 100′, the chair storage device 100″ also rests against the rear legs 22c and 22d when it is in the position shown in FIG. 4a although it also rests partially against the upstanding back of the chair 18 as will be appreciated.

With regard to all of the embodiments illustrated in FIGS. 2a-2c, 3a-3b, and 4a-4b, the chair storage devices 100, 100′, and 100″, respectively, maybe formed of a rigid material such as plastic or the like or of a material such as canvas, vinyl or other any fabric for flexibility and durability.

Finally, with regard to all of the embodiments illustrated and described above, it will be appreciated that the device may be utilized to ship educational materials in the pocket or pockets in addition to adding storage to a chair for the educational materials in a classroom environment following shipment

From the foregoing, it will be understood by one of ordinary skill in the art that the teachings of the invention can be used to provide a chair storage device for materials such as those used in an educational environment that facilitates better utilization of precious space particularly in the classroom in a product of inexpensive but yet durable construction.

What is claimed is:

1. A device for adding storage to a chair having a seat, comprising:
a pocket adapted to be supported adjacent the seat of the chair; and
means for securing the pocket to the chair adjacent the seat thereof.

2. The device of claim 1 wherein the chair includes a back upstanding from the seat and the pocket securing means includes a continuous strap secured to opposite sides of the pocket so as to be looped around the back of the chair.

3. The device of claim 1 wherein the chair includes a back upstanding from the seat and the pocket securing means includes a string secured to each of opposite sides of the pocket so as to be tied together about the back of the chair.

4. The device of claim 1 wherein the chair includes a back upstanding from the seat and the pocket securing means includes a hollow sleeve extending across a back surface of the pocket to be slipped down over the back of the chair.

5. The device of claim 1 wherein the chair includes a pair of opposite side supports and the device includes a seat portion integral with a top edge of a back surface of the pocket so as to be positioned to cover the seat of the chair.

6. The device of claim 5 wherein the opposite side supports each include a pair of legs and the pocket securing means includes a pair of straps on each corner of the seat portion so as to be secured to one of the legs of the chair.

7. A device for adding storage to a chair having a seat, comprising:
a pair of pockets each of which is adapted to be supported adjacent the seat of the chair on opposite sides thereof; and
a seat portion integral with a top edge of a back surface of each of the pockets so as to cover the seat of the chair.

8. The device of claim 7 wherein the chair includes a pair of opposite side supports each defined by a pair of legs and the pockets rest against the respective pairs of legs on opposite sides of the chair when the seat portion covers the seat of the chair.

9. The device of claim 8 wherein the pair of pockets and the seat portion are both formed of a flexible material.

10. The device of claim 9 wherein the flexible material has indicia located on at least one visible surface thereof.

11. The device of claim 8 wherein the pair of pockets and the seat portion are both formed of a rigid material.

12. The device of claim 11 wherein the rigid material has indicia located on at least one visible surface thereof.

13. The device of claim 7 further including means for securing the pockets to the chair adjacent the seat thereof.

14. The device of claim 13 wherein the chair includes a pair of opposite side supports each defined by a pair of legs and the pocket securing means includes a pair of straps on each corner of the seat portion so as to be secured to one of the legs of the chair.

15. The device of claim 7 wherein the pair of pockets and the seat portion are both formed of a flexible material.

16. The device of claim 7 wherein the seat portion includes a padded cushion to directly overlie the seat of the chair.

17. The device of claim 16 further including means for securing the pockets to the chair adjacent the seat thereof.

18. The device of claim 17 wherein the chair includes a pair of opposite side supports each defined by a pair of legs and the pocket securing means includes at least one strap on each side of the seat portion so as to be secured to one of the legs of the chair.

19. A device for adding storage to a chair having a seat supported on four legs and a back upstanding from the seat, comprising:
a single pocket adapted to be supported adjacent the seat of the chair against a pair of the legs defining a side support;
a seat portion integral with a top edge of a back surface of the pocket to substantially cover the seat of the chair and
means for securing the seat portion to the chair with the pocket supported against the pair of legs defining the side support.

20. The device of claim 19 wherein the seat portion securing means includes a pair of straps on each corner of the seat portion opposite the pocket so as to be secured to one of the legs of the chair opposite the pair of legs defining the side support.

21. The device of claim 19 wherein the single pocket and the seat portion are both formed of a flexible material.

22. The device of claim 21 wherein the flexible material has indicia located on at least one visible surface thereof.

23. The device of claim 19 wherein the single pocket and the seat portion are both formed of a rigid material.

24. The device of claim 23 wherein the rigid material has indicia located on at least one visible surface thereof.

25. A device for adding storage to a chair having a seat supported on four legs and a back upstanding from the seat, comprising:
a single pocket adapted to be supported adjacent the seat of the chair against a pair of the legs defining a rear support; and
means for securing the pocket to the chair with the pocket supported against the pair of legs defining the rear support.

26. The device of claim 25 wherein the pocket securing means includes a continuous strap secured to opposite sides of the pocket so as to be looped around the back of the chair at the level of the seat of the chair

27. The device of claim 25 wherein the pocket securing means includes a string secured to each of opposite sides of the pocket so as to be tied together about the back of the chair at the level of the seat of the chair.

28. The device of claim 25 wherein the pocket securing means includes a hollow sleeve on an upper back surface portion of the pocket to be slipped down over the back of the chair to the level of the seat of the chair.

29. The device of claim 25 wherein the single pocket and the seat portion are both formed of a flexible material.

30. The device of claim 29 wherein the flexible material has indicia located on at least one visible surface thereof.

31. The device of claim 25 wherein the single pocket and the seat portion are both formed of a rigid material.

32. The device of claim 31 wherein the rigid material has indicia located on at least one visible surface thereof.
